(19) United States
(12) Patent Application Publication
(10) Pub. No.: US 2008/0173107 A1
(43) Pub. Date: Jul. 24, 2008

(54) Combination pressure and acceleration sensor

(75) Inventors: Marc Leach, West Bloomfield, MI (US); Jeremy Tavares, Dexter, MI (US); Colm Boran, Novi, MI (US)

Correspondence Address: AUTOLIV ASP, 3350 AIRORT ROAD, OGDEN, UT, 84405, US

(73) Assignee: Autoliv ASP, Inc.

(21) Appl. No.: 11/655,611

(22) Filed: Jan. 19, 2007

(51) Int. Cl. G01M 19/00

(52) U.S. Cl. 73/865.3

(57) ABSTRACT

A sensor assembly for impact detection for use in a motor vehicle including a housing, a pressure transducer sensitive to pressure, and an accelerometer sensitive to acceleration. The pressure transducer and the accelerometer are each attached to the housing and the housing is attached to a location in the vehicle conducive to measuring pressure and acceleration signals corresponding to an impact event. The sensor assembly is configured to provide two independent signals (one for pressure and one for acceleration) to a control unit. The control unit compares both signals to confirm occurrence of the impact event in order to deploy automatic safety devices to protect vehicle occupants while avoiding inadvertent deployment of the safety devices.

### BACKGROUND

1. Field of the Invention

The present invention generally relates to motor vehicle safety systems. More specifically, the invention relates to automotive safety systems having redundant pressure and acceleration sensors to determine the occurrence of an impact event for deployment of automatic safety devices.

2. Description of Related Art

Vehicle safety systems may include automatic safety devices, for example, inflatable restraints such as airbags and seat belt pretensioners. A control unit activates these devices when it detects an impact event. The control unit needs to reliably detect these events since inadvertent deployment of safety systems is highly undesirable. One way this may be accomplished by using redundant pressure sensors and acceleration sensors.

When an impact event occurs, body panels of a motor vehicle may deform causing changes in air pressure within a body cavity of the motor vehicle. The impact event will also impart a sudden acceleration to the motor vehicle at substantially the same time as the change in pressure. Therefore, to confirm the occurrence of the impact event it is desirable to monitor both the pressure change and acceleration at a single location within the vehicle. The control unit then compares a signal from the pressure sensor with a signal from the acceleration sensor. If both sensors register a change exceeding a certain predetermined threshold at substantially the same time, the control unit will positively determine an impact event has occurred and deploy safety devices. Therefore, having two sensors in the same location reduces the chance of a false positive determination of the impact event.

Another benefit of redundant sensors is if one of the sensors fails, the control unit may be configured to determine that a fault condition has occurred. In a fault condition, the control unit will switch to monitoring only the operative sensor for the occurrence of an impact event. In this way, redundant sensors allow the control unit to continue to respond to impacts, even if one of the sensors fail. This also means it is important for the sensors to be located within the motor vehicle in a location where a distinct change in both pressure and acceleration are likely should an impact occur. However, these locations may have a relatively small internal volume.

For the above reasons, it is important for both sensors to measure the properties of the same location as much as possible. Previously this was accomplished by placing more than one sensor assembly in the vehicle, one monitoring pressure and one monitoring acceleration, in each location. This has the disadvantage that, depending on the size of each device, the sensors may be spaced relatively far apart from one another or be limited to sections of the vehicle having larger internal volumes. Spacing the devices apart may result in a small delay between the two signals, or the larger sections of the vehicle may not be well suited for providing an appropriate pressure or acceleration change. In addition, having two separate devices is more costly since they require additional mounting hardware and electrical connectors.

In view of the above, it is apparent that there exists a need for a sensor assembly capable of measuring both pressure and acceleration of a single location of the vehicle having minimal cost and high reliability.

### SUMMARY OF THE INVENTION

In satisfying the above need, as well as overcoming the enumerated drawbacks and other limitations of the related art, the present invention provides a sensor assembly for impact detection for use in a motor vehicle. The sensor assembly includes a housing, a pressure transducer sensitive to pressure and an accelerometer sensitive to acceleration. The pressure transducer and the accelerometer are each attached to the housing and the housing is attached to a location in the vehicle conducive to measuring pressure and acceleration corresponding to an impact event. The impact events detected may include side impacts, front impacts, rear impacts and other types of impacts.

The sensor assembly provides two independent signals to a control unit. The control unit compares both signals to confirm an occurrence of the impact event. Upon confirmation of the impact event, the control unit sends an activation signal to deploy appropriate automatic safety devices of the motor vehicle to protect vehicle occupants. The safety devices may include any crash deployed system, including examples such as front airbags, side airbags, side curtain airbags, and seat belt pre-tensioning devices.

According to one embodiment, the accelerometer is sensitive to changes in acceleration along a single sensing axis. In other embodiments, the accelerometer may be sensitive to changes along two or three sensing axes.

The location of the control unit in the vehicle is separate from the location of the sensor assembly. The location of the sensor assembly in the vehicle is conducive to detecting a single force component of the impact event acting along a single sensing axis. Advantageously, the location in the vehicle may also be conducive to detecting multiple force components of the impact event acting along multiple axes of orientation.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic illustration of a sensor assembly according to the present invention coupled to a control unit and a safety device of a motor vehicle;

FIG. 2 is an illustration showing one possible location of the sensor assembly of FIG. 1 within the motor vehicle;

FIG. 3 is an illustration showing a second possible location of the sensor assembly of FIG. 1 within the motor vehicle.

### DETAILED DESCRIPTION

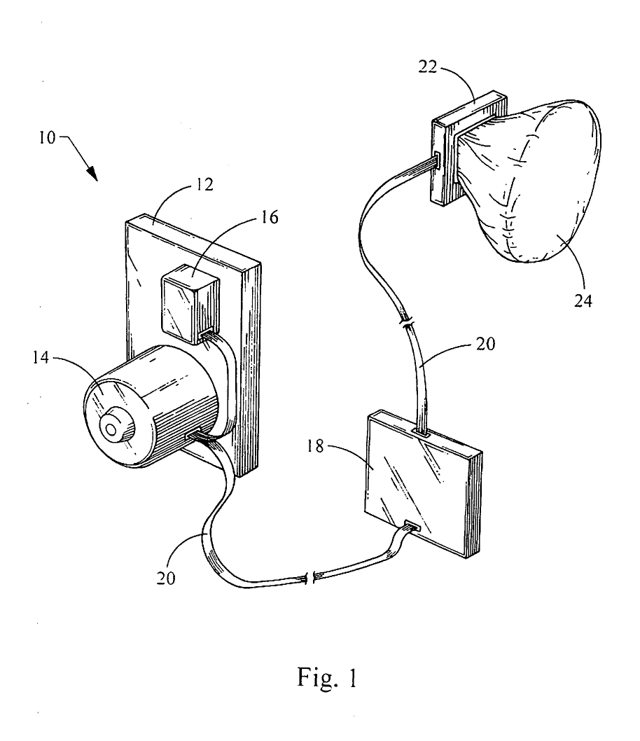

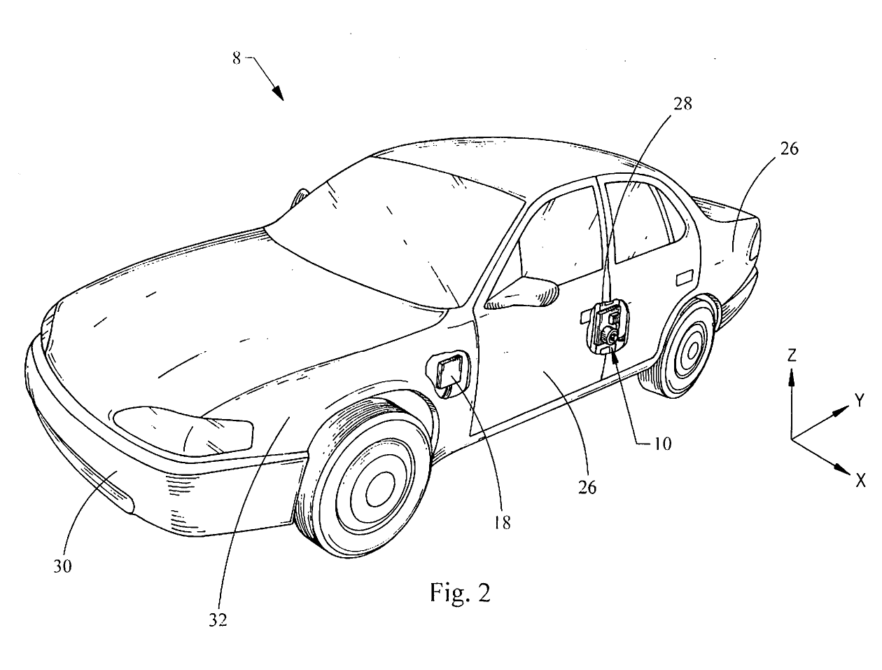

A sensor assembly for use in a motor vehicle 8 (see FIG. 2) embodying the principles of the present invention is illustrated in FIG. 1 and designated at 10. As its primary components, the sensor assembly 10 includes a housing 12, and at least two sensors: a pressure transducer 14 for measuring air pressure and an accelerometer 16 for measuring acceleration. The pressure transducer 14 and the accelerometer 16 are of a type configured for use in automotive safety systems having, for example, very fast response times to changes in pressure and acceleration. The accelerometer 16 may be sensitive to acceleration changes along at least one sensing axis, for example the X-axis, or it may be sensitive to changes in multiple sensing axes (i.e. the Y-axis and the Z-axis).

As best seen in FIG. 2, a control unit 18 is located separately within the motor vehicle 8, away from the sensor assembly 10. The control unit 18 is configured to receive signals from the sensor assembly 10 to continuously monitor the pressure changes and acceleration measured by the pressure transducer 14 and the accelerometer 16. Returning to FIG. 1, the signals may be transmitted to the control unit 18 by, for example, electrical cables 20. However, different embodiments may use radio transmission, optical fibers, or other appropriate means. The pressure transducer 14 and the accelerometer 16 are each attached to the housing 12, and the housing 12 is attached to a vehicle location in the motor vehicle 8 likely to experience changes in pressure and acceleration during an impact event.

The control unit 18 is also in communication with safety devices 22 of the motor vehicle 8 by the electrical cables 20. If an impact event is confirmed, the control unit 18 sends an activation signal via the cables 20 to deploy the safety devices 22. The safety devices 22 may be any devices appropriate for protecting an occupant (not shown) of the motor vehicle 8 from injury in the event of an impact. For example, in the embodiment of FIG. 1 the safety device 22 is shown as a front airbag 24 in an inflated condition. One example of a front airbag 24 is disclosed in U.S. Pat. No. 5,775,729 which is herein incorporated by reference. Other appropriate safety devices may also include, but are not limited to, side airbags, side curtain airbags, and seat belt pretensioners. Examples of each of these safety devices 22 are disclosed in U.S. Pat. Nos. 6,851,706, 6,902,187, and 6,729,649 which are herein incorporated by reference. The motor vehicle 8 may include as few as one safety device 22 or it may include various combinations of safety devices 22.

The control unit 18 may be configured to deploy all of the safety devices 22 upon confirmation of any impact event. On the other hand, it may distinguish between different types of impacts and only deploy those devices appropriate for each type of impact. For example, if the control unit 18 confirms the occurrence of a pure side impact in a motor vehicle 8 having front and side airbags, the control unit may only activate the side airbags and leave the front airbags inactive if appropriate.

The sensor assembly 10 provides two signals, one from the pressure transducer 14 and one from the accelerometer 16, to the control unit 18. The control unit 18 is preferably a digital control unit, but may be any device capable of monitoring and comparing signals from the pressure transducer 14 and the accelerometer 16. Appropriate software and hardware within the control unit 18 reads a voltage from the pressure transducer 14 and a voltage from the accelerometer 16 both of which are proportional to the respective pressure and acceleration acting on the vehicle. If an impact occurs, the pressure transducer 14 and accelerometer 16 will generate electrical signals proportional to the pressure and acceleration generated by the impact. The control unit 18 then determines if an impact occurred by reading these signals and comparing them to predetermined threshold values stored within the control unit 18.

Referring to FIG. 2, the vehicle location is chosen based on the fact that when an impact event occurs, a body panel 26 of the motor vehicle 8 will deform and cause changes in air pressure within a body cavity of the motor vehicle 8. In addition, the impact event will also impart a sudden acceleration to the motor vehicle 8 at substantially the same time as the change in pressure. Thus, to confirm the occurrence of the impact event, it is beneficial to monitor both the pressure and acceleration in a single location. The control unit 18 then compares the signal from the pressure transducer 14 and the accelerometer 16 and if both register a change exceeding the predetermined threshold value at substantially the same time, the control unit 18 will positively determine an impact event has occurred. This has the benefit of minimizing the chance of a false positive determination by the control unit 18.

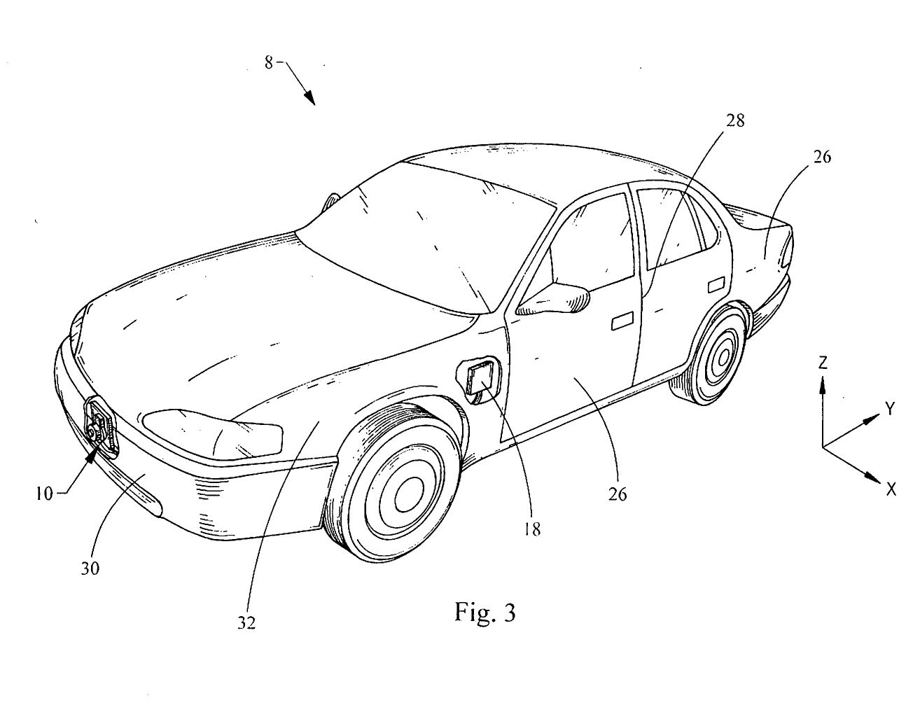

Therefore, it is important that the sensor assembly 10 be located within the motor vehicle 8 in a location where a distinct change in both pressure and acceleration are likely should an impact occur. While only a single sensor assembly 10 is shown in FIG. 2, other embodiments may use multiple sensor assemblies located in multiple locations throughout the vehicle. Depending on the needs of a given application, these locations may be selected such that only impacts acting along a single axis (i.e. the X-axis or side) may result in sufficient pressure and acceleration changes to be useful in detecting an impact event. Other locations may be selected that respond to impacts acting along multiple axes (i.e. the X-axis and the Y-axis or side and front). For example, in order to reliably detect side impacts the sensor assembly 10 may be located in proximity to a “B” pillar 28 of the motor vehicle 8. In another example, shown in FIG. 3, the sensor assembly 10 may be located in proximity to a front bumper 30 to detect front impacts.

Each of the above locations 28 and 30 are examples of single axis locations since, for example, a cavity within the front bumper 30 may only experience a significant pressure change from a front impact and not respond appreciably to a side impact. However, a front quarter panel 32 is an example of a multi-axis location. In this example, a cavity formed by the front quarter panel 32 is likely to experience significant pressure changes from both a side impact (i.e. the X-axis) and a front impact (i.e. the Y-axis). This is because portions of the front quarter panel 32 are disposed on both the side and the front of the vehicle 8.

Another benefit of redundant sensors is if one of the two sensors 14 and 16 of the sensor assembly 10 were to fail, the control unit 18 may be configured to determine a fault condition has occurred. In a fault condition, the control unit 18 will only monitor the operative sensor 14 or 16 for the occurrence of an impact event. In this way, redundant sensors allow the control unit 18 to continue to be able to respond appropriately to impacts even if the pressure transducer 14 or the accelerometer 16 fails.

For the above reasons, it is important that both the pressure transducer 14 and accelerometer 16 measure the properties of the same location within the vehicle. Previously this was accomplished by placing more than one sensor device in the vehicle for detection of acceleration and pressure. However, this has the disadvantage that, depending on the size of each device, they may be spaced further apart from one another than is desirable or they may be limited to sections of the vehicle having relatively large internal volumes. This is not desirable because spacing the devices apart may result in a delay between the two signals. In addition, the larger sections of the vehicle may not be sufficiently responsive to pressure changes or acceleration in an impact. Furthermore, two separate devices are more costly, and require additional mounting hardware and electrical connectors.

The present invention solves these problems by incorporating both the pressure transducer 14 and accelerometer 16 into a single housing 12 for mounting to the vehicle. This allows the space occupied by the sensor assembly 10 to be reduced and it also allows the separation between the pressure transducer 14 and the accelerometer 16 to be minimized.

In one embodiment, the pressure transducer 14 and the accelerometer 16 may be separate devices mechanically and electrically combined within the housing 12 of the sensor assembly 10. In another embodiment (not shown), the sensor assembly 10 may be formed as a single solid-state unit. In this embodiment, the housing 12 may include a printed circuit board (PCB) to which the pressure transducer 14 and the accelerometer 16 are electrically and mechanically coupled. As a result, rather than attaching the cables 20 to both the pressure transducer 14 and accelerometer 16 as shown in FIG. 1, the cables 20 may be attached only to the PCB or an appropriate connector thereon. In either embodiment, the entire sensor assembly 10 is installed as a single unit within a given location such as that shown in FIGS. 2 and 3.

It should also be noted that while both the pressure transducer 14 and accelerometer 16 are shown disposed on the same side of the housing 12 in FIG. 1, other embodiments may dispose the transducer 14 and accelerometer 16 on opposing sides of the housing 12. In addition, depending on the application, it may be desirable to dispose the sensor assembly 10 within a protective case (not shown). In one example, the protective case may substantially surround the housing 12, pressure transducer 14 and accelerometer 16. An opening may be provided in proximity to the pressure transducer 14 to allow air, or another fluid, to engage the pressure transducer 14. A second opening may optionally be provided for passage of the cables 20, and/or the case may include a connector to which the pressure transducer 14 and accelerometer 16 may be electrically coupled. The cables 20 may be attached to the connector.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. A sensor assembly for impact detection for use in a motor vehicle, the sensor assembly comprising:
a housing, a pressure transducer sensitive to pressure, and an accelerometer sensitive to acceleration; wherein
the pressure transducer and the accelerometer are each attached to the housing, the housing being disposed in a location in the vehicle conducive to measuring pressure and acceleration acting on the vehicle including those corresponding to an impact event.

2. The sensor assembly according to claim 1 wherein a pressure signal from the pressure transducer and an acceleration signal from the accelerometer are provided to a control unit.

3. The sensor assembly according to claim 2 wherein the acceleration signal from the accelerometer is proportional the acceleration acting on the vehicle.

4. The sensor assembly according to claim 2 wherein the pressure signal from the pressure transducer is proportional to the pressure acting on the vehicle.

5. The sensor assembly according to claim 2 wherein the sensor assembly is further configured to provide the remaining pressure signal or acceleration signal to the control unit upon failure of one of the pressure transducer and the accelerometer.

6. The sensor assembly according to claim 2 wherein the pressure signal and the acceleration signal are compared by the control unit to confirm the impact event.

7. The sensor assembly according to claim 6 wherein the control unit sends an activation signal to appropriate safety devices of the motor vehicle upon confirmation of the impact event.

8. The sensor assembly according to claim 7 wherein the safety devices include at least one of front airbags, side airbags, side curtain airbags, and seat belt pretensioning devices.

9. The sensor assembly according to claim 1 wherein the impact event is a side impact, a front impact, a rear impact, or a roll over event.

10. The sensor assembly according to claim 2 wherein the control unit is located separately from the sensor assembly in the vehicle.

11. The sensor assembly according to claim 1 wherein the accelerometer is sensitive to changes in acceleration along one sensing axis.

12. The sensor assembly according to claim 1 wherein the accelerometer is sensitive to changes in acceleration along two sensing axes.

13. The sensor assembly according to claim 1 wherein the accelerometer is sensitive to changes in acceleration along three sensing axes.

14. The sensor assembly according to claim 1 wherein the location in the vehicle is conducive to detecting a single force component of the impact event acting along a single axis.

15. The sensor assembly according to claim 1 wherein the location in the vehicle is conducive to detecting multiple force components of the impact event acting along multiple axes.

16. The sensor assembly according to claim 1 wherein the housing includes a printed circuit board.

17. The sensor assembly according to claim 16 wherein the pressure transducer and the accelerometer are electrically coupled to the printed circuit board.

18. The sensor assembly according to claim 17 wherein the pressure transducer and the accelerometer are disposed on the same side of the printed circuit board.

19. The sensor assembly according to claim 17 wherein the pressure transducer and the accelerometer are disposed on opposite sides of the printed circuit board

20. The sensor assembly according to claim 1 further comprising a protective case being disposed around the housing, the pressure transducer and the accelerometer, and the case includes an opening in proximity to the pressure transducer.
